(19) United States
(12) Patent Application Publication
(10) Pub. No.: US 2017/0020169 A1
(43) Pub. Date: Jan. 26, 2017

(54) HIGH ACID BEVERAGE PRODUCTS AND METHODS TO EXTEND PROBIOTIC STABILITY

(71) Applicant: Tropicana Products, Inc., Bradenton, FL (US)

(72) Inventors: Teodoro RIVERA, Algonquin, IL (US); Jessica OESTERLING, Chicago, IL (US); Yih Jennifer LEE, Port Barrington, IL (US)

(21) Appl. No.: 15/288,885

(22) Filed: Oct. 7, 2016

Related U.S. Application Data
(63) Continuation of application No. 12/626,226, filed on Nov. 25, 2009, now abandoned.

(51) Int. Cl. A23L 2/42; A23L 2/60; A23L 33/135; A23L 2/58; A23L 2/38; A23L 2/02; A23L 2/68

(52) U.S. Cl. CPC A23L 2/42; A23L 2/02; A23L 2/60; A23L 2/68; A23L 2/58; A23L 2/38; A23L 33/135; A23V 2002/00

(57) ABSTRACT

Beverage products are disclosed comprising at least one fruit juice, at least one sweetener, probiotic bacteria, and beta-glucan, where the beverage product has a pH of at most 4.5 and an acid level of 0.5%-1.0%. In certain exemplary and non-limiting embodiments, the beverage product has the characteristic that if tested after 45 days of storage in hermetically sealed individually sized 12 fl. oz. PET vessels stored in the dark or in otherwise UV shielded conditions at a refrigeration temperature of 35° F. the beverage product has an increased shelf life when compared to the same beverage product without beta glucan. Methods are provided for making such beverage products with extended probiotic stability.

### TECHNICAL FIELD

Aspects of the disclosed invention relate to high acid beverages with probiotics and other such beverage products (e.g., beverage concentrates, ready to drink liquid formulations, syrups, powders, etc.), and to methods to extend probiotic stability in high acid beverages and other beverage products, and to the use of beta-glucan in high acid beverages with probiotics.

### BACKGROUND

Probiotic bacteria (referred to here in some cases as probiotics) are live bacterial microbes that beneficially influence the health and nutrition of individuals by promoting a healthier microflora in the host's intestine. These microflora are dependent on substances fed to them from the diet of the host organism. Probiotics typically colonize in the large intestine and can serve either or both of at least two major roles: they can supplement the natural flora of the gastrointestinal tract with additional bacteria, and they can be effective in treating a number of health conditions, including, but not limited to (1) alleviation of intestinal disorders (e.g., constipation and diarrhea caused by an infection by pathogenic organisms, antibiotics, chemotherapy, etc.); (2) stimulation and modulation of the immune system; (3) anti-tumoral effects resulting from inactivation or inhibition of carcinogenic compounds present in the gastrointestinal tract by reduction of intestinal bacterial enzymatic activities (e.g., O-glucuronidase, azoreductase, nitroreductase, etc.); (4) reduced production of toxic final products (e.g., ammonia, phenols, other protein metabolites known to influence hepatic cirrhosis, etc.); (5) reduction of serum cholesterol and arterial pressure; (6) maintenance of mucosal integrity; (7) alleviation of lactose intolerance symptoms; and/or (8) prevention of vaginitis.

Examples of probiotic organisms include, but are not limited to, bacteria capable of growing, at least temporarily, inside the gastrointestinal tract, of displacing or of destroying pathogenic organisms, as well as providing other additional advantages to the host. The probiotics must maintain viability at least until they are ingested by the consumer.

Probiotics are sensitive to various environmental conditions and typically lack the ability to survive for long periods of time in “high acid” foods and beverage products (e.g., fresh citrus fruits, citrus fruit juices, foods containing citrus fruit juices, tomato sauce, etc.). For example, in fruit juice beverage products probiotics are sensitive to numerous environmental conditions, including, e.g., low pH, high acid content, high water activity, heat, air, light, and the inherent presence of polyphenols found in fruit juices, or other environmental influences. Thus, the viability (measured in colony forming units or CFU), and therefore the efficacy, of a high acid beverage supplemented with probiotics can be substantially reduced.

If an edible composition has a pH of less than 7 it is considered acidic. The acids present in an edible composition (e.g., a food or beverage product) contribute to the pH level. The more acid present, the lower the pH is likely to be. High-acid edible compositions are generally considered to have a natural pH of 4.6 or below. For example, one of the dominant nutrients in citrus fruit is acid, e.g., ascorbic acid (Vitamin C), and the pH level of orange juice is around 3.8. Acidic environments are known to denature vital proteins necessary for the growth of bacterial organisms. Consequently, the organisms die in an acidic environment. Many desirable probiotics grow best at pH values around 7.0.

The terms “acid content” and “degree of acidity” can be distinguished. The acid content is a measure of how much acid is present per unit volume of the edible composition. The degree of acidity is the actual pH value of the food or beverage. A high acid content gives a lower pH value, whereas a low acid content results in a higher pH value.

Heat (e.g., in the form of pasteurization) is routinely used to kill microbes that may be present in foods. In general, the cooler a product can be maintained, the greater the probiotic survival. Sunlight or artificial light can also kill at least some probiotics. Certain wavelengths of UV light are especially harmful. Due to probiotic sensitivity, environmental influences like high temperatures, high oxygen levels, moisture and direct light may result in beverages containing these organisms having a short shelf life. The result is a product with an inadequate shelf life, that is, a product whose decreased probiotic cell count determines the end of the product's shelf life, leading to higher costs and increased waste.

Various documents including, for example, publications and patents, are recited throughout this disclosure. All such documents are hereby incorporated by reference. The citation of any given document is not to be construed as an admission that it is prior art with respect to the present invention. To the extent that any meaning or definition of a term in this written document conflicts with any meaning or definition of the term in a document incorporated by reference, the meaning or definition implied or assigned to the term in this written document shall govern.

### BRIEF SUMMARY

The following presents a simplified summary of aspects of the inventive products, formulations and methods disclosed here. This summary is not an extensive overview, and it is not intended to identify all or only key or critical elements or to delineate the scope of the inventive products, formulations and methods covered by the claims. The following summary merely presents some concepts and aspects of the disclosure in a simplified form as a prelude to the more detailed description provided below of certain exemplary and non-limiting embodiments of the invention.

In accordance with a first aspect, beverage products are provided which comprise at least one fruit juice, at least one sweetener, probiotic bacteria, and beta-glucan, where the beverage product has a pH of at most 4.5 and an acid level between 0.5%-1.0% by weight. The fruit juice can be any suitable juice or combination of juices compatible with the probiotic bacteria and beta glucan in the particular beverage product formulation, as discussed further below. In certain exemplary and non-limiting embodiments, the fruit juice consists essentially of not-from-concentrate orange juice. In certain exemplary and non-limiting embodiments, the fruit juice consists essentially of from-concentrate orange juice. In certain exemplary and non-limiting embodiments, the fruit juice may include, but is not limited to, orange juice, pineapple juice, mango juice, grapefruit juice, lemon juice, lime juice, and the like or combinations thereof. In certain exemplary and non-limiting embodiments, the beverage product comprises at least one additional fruit juice, e.g., the beverage product comprises at least two additional fruit juices. In certain exemplary and non-limiting embodiments, the fruit juice may comprise 10%-100% by weight of the beverage product. In certain exemplary and non-limiting embodiments, the sweetener comprises a natural non-nutritive sweetener and may be selected from the group consisting of a rebaudioside, a steviol glycoside, Stevia rebaudiana extract, Lo Han Guo, mogroside V, monatin, glycyrrhizin, thaumatin, monellin, brazzein and mixtures of any of them. In certain exemplary and non-limiting embodiments, the natural non-nutritive sweetener is selected from the group consisting of rebaudioside A, rebaudioside B, rebaudioside C, rebaudioside D, rebaudioside E, steviolbioside, dulcoside A, and a combination of any of them. In certain exemplary and non-limiting embodiments, the probiotic comprises Bifidobacterium spp., Lactobacillus spp., or mixtures of any of them. In certain exemplary and non-limiting embodiments, beta-glucan may be derived from at least one of oat bran, rolled oats, whole oat flour, oatrim, whole grain barley, dry milled barley and mixtures of any two or more of them. In certain exemplary embodiments, the beverage products additionally include one or more beverage ingredients suitable for use in such beverage products, including, e.g., one or more of any of the additional beverage ingredients disclosed below. In certain exemplary and non-limiting embodiments, the beverage product further comprises at least one additional ingredient selected from the group consisting of taste modifiers, organic acids, flavorants, vitamins, minerals, buffering agents, colorants, and mixtures of any of them. In certain exemplary and non-limiting embodiments, the beverage product has the characteristic that if tested after 45 days of storage in hermetically sealed 12 fl. oz. PET vessels stored in the dark or in otherwise UV shielded conditions at a refrigeration temperature of 35° F. the beverage product has an increased shelf life when compared to the same beverage product without the beta-glucan. In accordance with certain aspects, a beverage product is provided that comprises at least 40% not-from-concentrate (NFC) orange juice, a sweetener component comprising at least one natural non-nutritive sweetener, probiotic bacteria, at least 0.20% beta glucan, where the beverage has a pH of at most 4.5, an acid level of 0.70%-0.80%, and the probiotic bacteria comprise viable bacteria at a concentration of at least 1.0×10⁹ CFU/12 fl. oz., e.g., from 1.0×10⁹ to 1.0×10¹² CFU/12 fl. oz., of the packaged beverage product when tested after storing for 45 days in hermetically sealed 12 fl. oz. PET vessels stored in the dark or in otherwise UV shielded conditions at 35° F. All percentages recited in the description, disclosure and the appended claims are percent by weight of the fully formulated beverage product unless otherwise stated.

In certain exemplary and non-limiting embodiments, a beverage product formulation is provided which comprises at least one fruit juice, at least one sweetener, probiotic bacteria at a concentration of at least 1.0×10⁹ CFU/12 fl. oz., e.g., from 1.0×10⁹ to 1.0×10¹² CFU/12 fl. oz., and beta-glucan, where the beverage product formulation has a pH of at most 4.5 and an acid level between 0.5% and 1.0%. In certain exemplary and non-limiting embodiments, such beverage product formulations have at least a 10% greater shelf life, e.g., a shelf life that is at least 25% greater or even 50% greater than it would be for the same formulation without the beta-glucan, when stored in hermetically sealed 12 fl. oz. PET vessels in the dark or in otherwise UV shielded conditions at 35° F. It should be understood that while the concentration of probiotic bacteria is given as per 12 fl. oz. of the beverage product formulation given here, actual commercial embodiments may include any certain volume of the disclosed beverage product formulation so long as the minimum per volume concentration of probiotic is maintained.

In certain exemplary and non-limiting embodiments, a beverage product formulation is provided which comprises at least one fruit juice, at least one sweetener, probiotic bacteria at a concentration of at least 1.0×10⁹ CFU/12 fl. oz., e.g., from 1.0×10⁹ to 1.0×10¹² CFU/12 fl. oz., and beta-glucan, where the beverage product formulation has a pH of at most 4.5 and an acid level between 0.5% and 1.0%. In certain exemplary and non-limiting embodiments, such beverage product formulations have at least a 10% greater probiotic concentration, e.g., a probiotic concentration that is at least 20% greater, at least 25% greater, at least 50% greater, at least 75% greater or even at least 90% greater than it would be for the same formulation without the beta-glucan, when tested after 45 days in hermetically sealed 12 fl. oz. PET vessels stored in the dark or in otherwise UV shielded conditions at 35° F. In certain exemplary and non-limiting embodiments, such beverage product formulations have at least a 10% greater probiotic concentration, e.g., a probiotic concentration that is at least 20% greater, at least 25% greater, at least 50% greater, at least 75% greater or even at least 90% greater than it would be for the same formulation without the beta-glucan, when tested after 63 days in hermetically scaled 12 fl. oz. PET vessels stored in the dark or in otherwise UV shielded conditions at 35° F. In certain exemplary and non-limiting embodiments, such beverage product formulations have at least a 10% greater probiotic concentration, e.g., a probiotic concentration that is at least 20% greater, at least 25% greater, at least 50% greater, at least 75% greater or even at least 90% greater than it would be for the same formulation without the beta-glucan, when tested after 70 days in hermetically sealed 12 fl. oz. PET vessels stored in the dark or in otherwise UV shielded conditions at 35° F.

In certain exemplary embodiments, the beverage product formulations additionally include one or more beverage ingredients suitable for use in such beverage products, including, e.g., one or more of any of the additional beverage ingredients disclosed below.

In accordance with another aspect, methods are provided for preparing a beverage product. Such methods comprise combining a number of ingredients to form a first mixture, all or some of which are optionally pre-combined in any order. The ingredients include at least one fruit juice, at least one sweetener, and beta-glucan. In certain exemplary embodiments, the beverage products additionally include one or more beverage ingredients suitable for use in such beverage products, including, e.g., one or more of any of the additional beverage ingredients disclosed below. The first mixture is heated to pasteurize it before the addition of the probiotic bacteria. The probiotic bacteria may be introduced to the first mixture after the pasteurization step and before packaging the beverage or after packaging the beverage. The beverage can be packaged in any suitable containers, e.g., in single serving size containers or multi-serve containers. Typically, such single serving size containers are about 4 fl. oz. to 16 fl. oz. in size, e.g., 6 fl. oz., 8 fl. oz. or 12 fl. oz. While specific examples have been described, those skilled in the art will appreciate that there are numerous variations and permutations of the exemplary products, formulations and methods that fall within the spirit and scope of the disclosure and will still accomplish similar results.

The shelf life of a beverage product containing probiotics may be defined as the time duration during which it retains at least a certain concentration or level of viable probiotics, e.g., at least 1.0×10⁹ CFU/12 fl. oz., or in some cases at least 5.0×10⁹ CFU/12 fl. oz. Without wishing to be bound by theory, it is believed that in at least certain exemplary and non-limiting embodiments the combination of probiotics and beta-glucan in the beverage products and methods disclosed here results in an encapsulation (either partially or wholly), complex, and/or emulsion of the probiotic organism with the beta-glucan. Again without wishing to be bound by theory, it is believed that such encapsulation, complex and/or emulsion serves to protect the probiotic and, so, to extend its viability in the beverage product and thereby extend the shelf life of the product. When the combination of probiotic and beta-glucan is delivered in a beverage product disclosed here, it is now found to result in an extended shelf life, i.e., an increased number or percent of viable probiotic bacteria surviving over time. It is also possible that the encapsulation, complex and/or emulsion product formed by the beta-glucan and probiotic could change over the shelf life of the beverage product. The beta-glucan may also function as a food source for the probiotic.

### BRIEF DESCRIPTION OF THE DRAWINGS

A more complete understanding of the present disclosure and the advantages thereof may be acquired by referring to the following description in consideration of the accompanying drawings, in which like reference numbers indicate like features, and where:

FIG. 1 graphically illustrates the concentration of probiotic bacteria over time when the bacteria are inoculated into an orange juice formulation both with and without beta-glucan. The results indicate a higher concentration of viable bacteria after 45 days in orange juice beverages including beta-glucan when compared to similar orange juice beverages without beta-glucan. Specifically, after a period of 45 days the CFU/12 fl. oz. of orange juice beverage containing beta-glucan was at least 50% higher than the same beverage without beta-glucan.

### DETAILED DESCRIPTION OF EXEMPLARY EMBODIMENTS

In the following description of the various embodiments, reference is made to the accompanying FIGURE, which forms a part hereof, and in which is shown by way of illustration various embodiments in which one or more aspects of the disclosure may be practiced. For convenience, the various embodiments discussed below are formulations, products, methods and the like. It is to be understood that other embodiments may be utilized and structural and functional modifications may be made without departing from the scope of the present disclosure.

Referenced here are trade names for components including various ingredients suitable for use in the exemplary beverage products, formulations and methods disclosed here. The inventors do not intend to be limited by materials under a certain trade name. Equivalent materials (e.g., those obtained from a different source under a different name or reference number) to those referenced here by trade name may be substituted and utilized in the descriptions here.

Certain exemplary and non-limiting embodiments of the beverage products or formulations disclosed here can maintain high probiotic bacterial viability rates and so achieve a long shelf life. These exemplary beverage products or formulations, from a starting concentration ranging from 1.0×10⁹-1.0×10¹² CFU/12 fl. oz., e.g., 1.0×10¹⁰ CFU/12 fl. oz., are capable of delivering at least 1.0×10⁹ CFU bacteria per 12 fl. oz. of beverage when consumed even after 45 days when stored in the dark or in otherwise UV shielded conditions at a temperature of 35° F. post-filling. In certain exemplary and non-limiting embodiments, fully one-half of the starting concentration of viable probiotic bacteria remains after 45 days, or 63 days, or even 70 days, when stored in the dark or in otherwise UV shielded conditions at a temperature of 35° F. post-filling.

As used here and in the appended claims, the term “probiotics”, “probiotic micro-organism” or “probiotic biomass” is understood to include any micro-organisms, cell content or metabolites from micro-organisms, having beneficial effects to its host. Therefore, yeasts, moulds and bacteria may be included. In certain exemplary embodiments, probiotic bacterial strains of Bifidobacterium may be used in the beverage products, formulations and methods disclosed here, including, e.g., B. breve, B. animalis (lactis), B. longum, B. bifidum. B. adolescentis, B. thermophilum, and B. infantis. Probiotic bacterial strains of the genus Lactobacillus may also be used, including, e.g., L. acidophilus, L. casei, L. rhamnosus, L. paracasei, L. johnsonii, L. reuteri and L. plantarum, L. lactis, L. bulgaricus.

EP 0862863 lists some examples for probiotics presently known. For example, strains of Lactobacillus plantarum (Lp299), Bifidobacterium lactis (HN019), or Bifidobacterium lactis (BB-12) may be used in certain non-limiting examples of the beverage products and formulations disclosed here. A selection of different probiotic strains is offered by Christian Hansen BioSystems A/S (CHL), 10-12 Boge All, P.O Box 407, DK-2970 Horsholm, Denmark. It will be within the ability of those skilled in the art, given the benefit of this disclosure, to select suitable additional or alternative strains of probiotic bacteria for use in various embodiments of the beverage products and formulations disclosed here.

In some exemplary and non-limiting embodiments, beverage products or formulations may contain bacteria from multiple species. In certain exemplary and non-limiting examples, when two bacteria are present in a beverage or formulation, the bacteria may be, for example, B. animalis (lactis) and L. rhamnosus.

The ratio of one bacterial species to the other may vary widely. The ratio may be from about 0.00000001 to 1, about 0.0000001 to 1, about 0.000001 to 1, about 0.00001 to 1, about 0.0001 to 1, about 0.001 to 1, about 0.01 to 1, about 0.1 to 1, or about 1 to 1.

Viable bacterial numbers are often reported as CFU, or colony forming units. One colony is formed by a single viable bacterium when the bacteria are plated at a suitable dilution for single colony formation. This is a standard technique known to microbiologists. Typically, the amount is expressed as the number of CFU in a liquid measure e.g., milliliters (ml), fluid ounces (fl. oz), etc. U.S. regulation 21 CFR 101.9(b)(5)(viii) defines a fluid ounce as exactly 30 ml. Sufficient numbers of viable bacteria may be necessary to obtain the beneficial effects of the probiotic bacteria. Often bacteria are packaged at a certain level of viable bacteria; however, before consumption, the levels may decrease preventing the consumer from acquiring a beneficial dose of bacteria. Indeed, the National Center for Complementary and Alternative Medicine (NCCAM) has identified several issues relating to the quality of probiotic products including: viability of the bacteria in the product, types and titer of bacteria in the product, and stability under storage. See NCCAM, “BACKGROUNDER: Biologically Based Practices: An Overview” (October, 2004). This document may be found at the website of the National Center for Complementary and Alternative Medicine (NCCAM).

The bacteria suitable for certain exemplary and non-limiting examples of the beverage products, formulations and methods disclosed here may be prepared in a variety of methods known in the art, including, for example, growth on media containing casein. Optionally, the bacteria may be grown without casein, providing a completely dairy-free bacterial preparation. In certain exemplary and non-limiting embodiments, the bacteria may be stored by refrigeration, freezing, or freeze-drying without diminishing viability below a desired level. In certain exemplary and non-limiting embodiments, the bacteria may be added to the beverage product or formulation while in the same state as they were stored, e.g., while frozen, freeze-dried, or refrigerated. In certain exemplary and non-limiting embodiments, the bacteria may be thawed prior to adding to the beverage product or formulation. In accordance with certain aspects, the bacteria may be frozen after growth and maintained in a frozen state until they are added to the beverage product or formulation. In accordance with certain aspects, the bacteria may also be freeze-dried and then measured, mixed and rehydrated in 0.10% peptone water prior to adding to the beverage product or formulation.

The term “shelf life” as used here refers to the length of time after a beverage is packaged that it meets the applicable criteria for sale and consumption, including having at least a requisite minimum concentration of the probiotics. In certain exemplary and non-limiting beverage embodiments, the shelf life is the time duration that the beverage meets such criteria and is otherwise suitable for consumption, when packaged in hermetically sealed 12 fl. oz. PET vessels and stored in the dark or in otherwise UV shielded conditions at a temperature of about 35° F., including continuing to have viable probiotics at a level of at least 1.0×10⁹ CFU/12 fl. oz. of the beverage. It should be understood, that the beverage products and formulations disclosed here can be stored and packaged in any suitable containers, including, e.g., containers of any desired size made of any suitable material(s). The forgoing definition of shelf life is given here for convenient reference and convenient explanation of the improved shelf life provided by some or all embodiments of the beverage products and formulations disclosed here. Those persons having ordinary skill in the art will understand from this disclosure, that corresponding or comparable improved shelf life will be achieved in some or all embodiments also under other storage or shelf life conditions, e.g., at other temperatures, in containers of other suitable materials and sizes, etc. while still accomplishing similar results.

In certain exemplary and non-limiting embodiments, the beverage products or formulations disclosed here exhibit the characteristic that after 45 days of storage in the dark or in otherwise UV shielded conditions at refrigeration temperatures (e.g., 35° F.) after preparation of the beverage, the number of bacteria contained in the beverage has a value anywhere from about 1.0×10⁹ CFU/12 fl. oz. to about 5.0×10⁹ CFU 12/fl. oz. of beverage of beverage. It should be understood that the term “about” is used here and in similar applications in this disclosure and the appended claims to account for ordinary inaccuracy and variability in measurement and the like. In certain exemplary and non-limiting embodiments, the beverage products or formulations disclosed here exhibit the characteristic that after 45 days of storage in the dark or in otherwise UV shielded conditions in refrigeration temperatures (e.g., 35° F.) after preparation of the beverage product, the number of bacteria contained in the beverage product is from about 1.0×10⁹ CFU/12 fl. oz. to about 5.0×10⁹ CF/12 fl. oz. of beverage product, and in some embodiments from about 2.0×10⁹ CFU/12 fl. oz. of beverage product to about 5.0×10⁹ CFU/12 fl. oz. of beverage product, and in some embodiments from about 3.0×10⁹ CFU/12 fl. oz. of beverage product to about 5.0×10⁹ CFU/12 fl. oz. of beverage product, and in some embodiments from about 4.0×10⁹ CFU/12 fl. oz. of beverage product to about 5.0×10⁹ CFU/12 fl. oz. of beverage product.

As discussed above, the fruit juice can be any suitable juice or combination of juices compatible with the probiotic bacteria and beta glucan in the particular beverage product or formulation. Without being bound by theory, it is believed that the combination of probiotics and beta-glucan results in an encapsulation (either partially or wholly), complex, and/or emulsion of the probiotic organism with the beta glucan. Again, without wishing to be bound by theory, it is believed that such encapsulation, complex and/or emulsion serves to protect the probiotic. When the combination of probiotic and beta-glucan is delivered in a beverage product or formulation disclosed here, it is now found to result in an extended shelf life, i.e., an increased number or percent of viable probiotic bacteria surviving over time. It is also possible that the encapsulation, complex and/or emulsion product formed by the beta-glucan and probiotic could change over the shelf life of the beverage product. The beta-glucan may also function as a food source for the probiotic.

In at least one exemplary method for preparing the beverage product or formulation disclosed here, the method comprises mixing together a number of ingredients to form a first mixture, all or some of which are optionally pre-combined in any order. The ingredients include at least one fruit juice, at least one sweetener, and beta-glucan. In certain exemplary embodiments, the beverage products additionally include one or more beverage ingredients suitable for use in such beverage products, including, e.g., one or more of any of the additional beverage ingredients disclosed below. The first mixture is heated to pasteurize before the addition of the probiotic bacteria. The probiotic bacteria may be introduced to the first mixture either after, e.g., just after, the pasteurization step or after, e.g., just after, packaging of the beverage. The beverage product can be packaged into bottles, cartons, or vessels, e.g., into sterilized single or multi-serving size containers. Typical such containers are about 4 fl. oz. to 16 fl. oz. in size, e.g., 6 fl. oz., 8 fl. oz. or 12 fl. oz. The containers can be sealed by suitable methods known in the art. The sealed containers can be shipped or stored optionally under refrigeration. Refrigeration temperatures typically have a range from about 32° F.-50° F. (0° C.-10° C.). Often, the refrigeration temperature is about 35° F.-43° F. (2° C.-6° C.).

The fruit juice(s) may be in any one or more of various forms including, e.g., liquids, concentrates, extracts, purees, pastes, pulps, and the like. A suitable fruit juice for the beverage includes, e.g., orange juice. Suitable fruit juice combinations for the beverage products and formulations disclosed here include, e.g., a mixture of any one or more of the juice from apple, orange, mango, pineapple, and coconut. Bacterial species that exhibit excellent survival in beverage products comprising these mixtures include, e.g., Bifidobacterium spp., Lactobacillus spp. or mixtures of any of them.

In certain exemplary and non-limiting embodiments, the beverage product or formulation comprises not-from-concentrate (NFC) and/or from-concentrate (FC) juice(s). Juices suitable for use in some or all of the beverage products and formulations disclosed here include, e.g., juices from fruit or vegetable sources. Certain exemplary and non-limiting examples of such beverage products or formulations comprise one or more citrus juices, e.g., a not-from-concentrate (NFC) orange juice. Other types of fruit or vegetable juices include but are not limited to juices of citrus fruit (e.g., orange, grapefruit, lemon, lime, tangerine, tangelo), apricot, apple, kumquat, mango, pear, peach, pineapple, papaya, passion fruit, grape, strawberry, raspberry, cranberry, currant, bean, blueberry, blackberry, acai, lychee, kiwi, pomegranate, watermelon, aronia, tomato, celery, cucurbits, onion, watercress, cucumber, carrot, parsley, beet, rhubarb, asparagus, potato, turnip, rutabaga, and a combination of any of them. In certain exemplary and non-limiting embodiments, the beverage product or formulation comprises fruit juice (e.g., orange juice and/or other citrus juice) in an amount from about 5% to about 100% by weight of the beverage product, e.g., about 10% to about 100% by weight, about 10% to about 90% by weight, about 10% to about 75% by weight, about 15% to about 50% by weight, or about 20% to about 30% by weight.

In certain exemplary embodiments, the beverage product or formulation may include a vegetable component, including, but not limited to, one or more vegetable juices, extracts, powders, skins, rinds, grinds, roots, pulps, homogenized pulps, purees, or any combination thereof. The vegetable component can be used in the beverage product or formulation in any suitable amount or concentration effective to achieve the level of taste desired. When included in the mixture, the ratio of fruit juice to vegetable juice may vary, depending on the manner in which the vegetable and fruit juices are mixed and/or the beverage product to be produced. The ratio of fruit to vegetable juice will vary to suit a particular application and can include, for example, 0:100, 100:0, 2:1, 3:1, or 3:2. In certain exemplary embodiments, the mixture of fruit juice and vegetable juice comprises about 80%-60%/a fruit juice and about 20%-40% vegetable juice. In certain exemplary embodiments, the fruit to vegetable juice ratio is about 80:20; however, other ratios are contemplated and within the scope of this disclosure.

Exemplary beverage products include, but are not limited to, any ingredient or any combination of ingredients, or any substance or any combinations of substances, that can be used or prepared for use as a beverage for a mammal and includes, but is not limited to, ready to drink liquid formulations, beverage concentrates, syrups, powders and the like. Exemplary beverage products include, but are not limited to, carbonated and non-carbonated beverages, fountain beverages, frozen ready-to-drink beverages, frozen carbonated beverages, beverage concentrates, powdered concentrates, coffee beverages, tea beverages, dairy beverages, flavored waters, enhanced waters, fruit juices, fruit juice-flavored drinks, fruit-flavored drinks, sports drinks, soy drinks, hydration drinks, energy drinks, fortified/enhanced water drinks, vegetable drinks, grain-based drinks, malt beverages, fermented drinks, yogurt drinks, kefir, alcoholic beverages, and mixtures of any of them. Beverage products further include, e.g., full calorie drinks/beverages and reduced-calorie (e.g., light, diet, zero calorie) drinks/beverages. Beverage products include bottle, can, and carton products and fountain syrup applications.

In certain exemplary and non-limiting embodiments disclosed here, beverage products include, e.g., ready to drink liquid formulations, beverage concentrates and the like. At least certain exemplary embodiments of the beverage products contemplated are prepared with an initial volume of juice or juice concentrate to which additional ingredients are added. Full strength beverage products can be formed from the beverage concentrate by adding further volumes of water and/or other solvents to the concentrate. In certain exemplary and non-limiting embodiments of the beverage products and formulations disclosed here, the solvent may include e.g., water, ethanol, glycerin, propylene glycol, benzyl alcohol, isopropanol, triacetin, or mixtures of any of them. In certain other embodiments, a full strength beverage product is directly prepared without the formation of a concentrate and subsequent dilution.

The terms “beverage concentrate,” and “syrup” are used interchangeably throughout this disclosure. At least certain exemplary embodiments of the beverage products contemplated are prepared with an initial volume of water to which additional beverage ingredients are added. Full strength beverage products can be formed from the beverage concentrate by adding further volumes of water to the concentrate (also known as diluting). Typically, for example, full strength beverage products can be prepared from the concentrates by combining approximately 1 part concentrate with between approximately 3 to approximately 7 parts water. In certain exemplary embodiments the full strength beverage product is prepared by combining 1 part concentrate with 5 parts water. In certain other embodiments, a full strength beverage is directly prepared without the formation of a concentrate and subsequent dilution.

In certain exemplary and non-limiting embodiments, the beverage product comprises juice with added water. Purified water can be used in the manufacture of certain exemplary embodiments of the beverage products or formulations disclosed here, and water of a standard beverage quality can be employed in order not to adversely affect beverage product or formulation taste, odor, or appearance. The water typically will be clear, colorless, free from objectionable minerals, tastes and odors, free from organic matter, low in alkalinity and of acceptable microbiological quality based on industry and government standards applicable at the time of producing the beverage product or formulation. In certain exemplary and non-limiting embodiments, water is added at a level of from about 0% to about 90% by weight of the beverage product, e.g., about 15% to about 80% by weight, about 40% to about 70% by weight, or about 50% to about 60% by weight. In certain exemplary embodiments the water used in beverages and concentrates disclosed here is “treated water,” which refers to water that has been treated to remove substantially all mineral content of the water prior to optional supplementation with any of the components described here as disclosed in U.S. Pat. No. 7,052,725. Methods of producing treated water are known to those of ordinary skill in the art and include deionization, distillation, filtration and reverse osmosis (“R-O”), among others. The terms “treated water,” “purified water,” “demineralized water,” “distilled water,” and “R-O water” are understood to be generally synonymous in this discussion, referring to water from which substantially all mineral content has been removed, typically containing no more than about 500 ppm total dissolved solids, e.g., no more than about 250 ppm.

Various sweeteners may be included in the formulations of the beverage products or formulations disclosed here. The sweeteners are edible consumables suitable for consumption and for use in beverage products. By “edible consumables” is meant a food or beverage or an ingredient of a food or beverage for human or animal consumption. Suitable sweeteners or sweetening agents used in certain exemplary embodiments disclosed here include a non-nutritive and natural beverage ingredient or additive (or mixtures of any of them) which provides sweetness to the beverage, i.e., which is perceived as sweet by the sense of taste. The perception of flavoring agents and sweetening agents may depend to some extent on the interrelation of elements. Flavor and sweetness may also be perceived separately, i.e., flavor and sweetness perception may be both dependent upon each other and independent of each other. For example, when a large amount of a flavoring agent is used, a small amount of a sweetening agent may be readily perceptible and vice versa. Thus, the oral and olfactory interaction between a flavoring agent and a sweetening agent may involve the interrelationship of elements.

Sweeteners suitable for use in various exemplary and non-limiting embodiments of the beverage products and formulations disclosed here include natural sweeteners. Suitable sweeteners and combinations of sweeteners are selected for the desired nutritional characteristics, taste profile, beverage product or formulation mouthfeel and other organoleptic factors. Natural sweeteners suitable for at least certain exemplary embodiments include, but are not limited to, erythritol, tagatose, sorbitol, mannitol, xylitol, maltose, rhamnose, trehalose, glycyrrhizin, malitol, lactose, Lo Han Guo (“LHG”), a rebaudioside, a steviol glycoside, Stevia rebaudiana extract, xylose, arabinose, isomalt, lactitol, maltitol, and ribose, protein sweeteners (e.g., thaumatin, monellin, brazzein, monatin, etc.), and the like or combinations thereof. Natural non-nutritive sweeteners suitable for some or all embodiments of the beverage products or formulations disclosed here include, but are not limited to, a rebaudioside (e.g., a rebaudioside juice concentrate or rebaudioside powder having a rebaudioside content of from about 0.005% to about 99%, e.g., from about 0.005% to about 1.0%), other steviol glycosides (e.g., a steviol glycoside juice concentrate or steviol glycoside powder having a stevioside content of from about 0.005% to about 99%, e.g., from about 0.005% to about 1.0%), Stevia rebaudiana extract, Lo Han Guo (e.g., LHG juice concentrate or LHG powder having a mogroside V content of from about 0.005% to about 99%), monatin, glycyrrhizin, thaumatin, monellin, brazzein, and the like or mixtures of any two or more of them. Also, in certain exemplary and non-limiting embodiments of the beverage products and formulations disclosed here, combinations of one or more natural sweeteners are used to provide the sweetness and other aspects of desired taste profile and nutritive characteristics. It should also be recognized that certain such sweeteners will, either in addition or instead, act as tastants, masking agents or the like in various embodiments of the beverage products and formulations disclosed here, e.g., when used in amounts below its (or their) sweetness perception threshold in the beverage product or formulation in question.

Certain exemplary and non-limiting embodiments of the beverage products and formulations disclosed here include natural non-nutritive sweeteners, including, but not limited to, rebaudioside A, rebaudioside B, rebaudioside C, rebaudioside D, rebaudioside E, steviolbioside, stevioside, dulcoside A, other steviol glycosides, Stevia rebaudiana extract, Lo Han Guo (e.g., LHG juice concentrate, LHG powder, or mogroside V), thaumatin, monellin, brazzein, monatin, and the like or mixtures of any two or more of them. LHG, if used, may have, for example, mogroside V content of from about 0.005% to about 99%. Optionally, the sweetener or sweetener component may include erythritol, tagatose, or a mixture of the two. Non-nutritive, high potency sweeteners typically are used at a level of milligrams per fluid ounce of beverage product, depending on various factors, e.g., their sweetening power, any applicable regulatory provisions of the country where the beverage product is to be marketed, the desired level of sweetness of the beverage product, etc. It will be within the ability of those skilled in the art, given the benefit of this disclosure, to select suitable additional or alternative sweeteners for use in various embodiments of the beverage products and formulations disclosed here.

As mentioned above, at least certain exemplary embodiments of the beverage products and formulations disclosed here may employ a steviol glycoside, a rebaudioside, Stevia rebaudiana extract or related compounds for sweetening. Stevia (e.g., Stevia rebaudiana Bertoni) is a sweet-tasting plant with leaves containing a complex mixture of naturally sweet diterpene glycosides. These sweeteners can be obtained, for example, by extraction or various other methods known in the art. Typically, these sweetening compounds are found to include, for example, stevioside, steviolbioside, the rebaudiosides (including, e.g., rebaudioside A, rebaudioside B, rebaudioside C, rebaudioside D, and rebaudioside E), and dulcoside A. In certain exemplary and non-limiting embodiments, a sweetener derived from Stevia is included in the beverage product in an amount between about 0.005%-1.00% by weight, e.g., between about 0.05%-1.0%, or between about 0.5%-1.0%.

The sweetener Lo Han Guo, which has various different spellings and pronunciations and is abbreviated here in some instances as LHG, can be obtained from fruit of the plant family Cucurbitaceae, tribe Jollifieae, subtribe Thladianthinae, genus Siraitia. LHG often is obtained from the genus/species S. grosvenorii, S. siamensis, S. silomaradjae, S. sikkimensis, S. africana, S. borneensis, and S. taiwaniana. Suitable fruit includes that of the genus/species S. grosvenorii, which is often called Luo Han Guo fruit. LHG contains triterpene glycosides or mogrosides, which constituents may be used as LHG sweeteners. Lo Han Guo is a potent sweetener which can be provided as a natural nutritive or natural non-nutritive sweetener. For example. Lo Han Guo juice concentrate may be a nutritive sweetener, and Lo Han Guo powder may be a non-nutritive sweetener. In certain exemplary and non-limiting embodiments, Luo Han Guo can be used as the juice or juice concentrate, powder, etc. LHG juice may include at least about 0.1% (e.g., from 0.1% to about 15%), mogrosides (e.g., mogroside V, mogroside IV, 11-oxo-mogroside V), siamenoside and mixtures of any of them. In certain exemplary embodiments, Mogroside V derived from LHG can be used as a natural non-nutritive sweetener. LHG can be produced, for example, as discussed in U.S. Pat. No. 5,411,755. Sweeteners from other fruits, vegetables or plants also may be used as natural or processed sweeteners or sweetness enhancers in certain exemplary embodiments of the beverage products and formulations disclosed here.

As used here, a “non-nutritive sweetener” is one which does not provide significant caloric content in typical usage amounts, i.e., is one which imparts less than 5 calories per 8 oz. serving of beverage product to achieve the sweetness equivalent of 10 Brix of sugar. Typically, Brix tables are used in the beverage industry to determine sugar content of a particular composition. The Brix level can be measured using any suitable technology, such as a refractometer, hydrometer, and the like. The Brix measurement defines the ratio of sugar to water and does not take into account the specific gravity of the composition. As used here, “reduced calorie beverage product” means a beverage product having at least a 25% reduction in calories per 8 oz. serving of beverage product as compared to the full calorie version, typically a previously commercialized full-calorie version. As used here, a “light beverage product” means a beverage product having at least ⅓ less calories per 8 oz. serving of beverage product as compared to the full calorie version, typically a previously commercialized full-calorie version. As used here, a “low-calorie beverage product” has fewer than 40 calories per 8 oz. serving of beverage product. In certain exemplary embodiments, the beverage product or formulation disclosed here is a light orange juice beverage product having about 50 calories per 8 oz. serving.

In certain exemplary and non-limiting embodiments, additional ingredients may be added to the beverage products and formulations disclosed here. These additional ingredients may also be referred to as food or beverage ingredients and include, but are not limited to, acidulants, colorants, flavorants, minerals, vitamins, fruit juices, fruit flavors, or other fruit products, other taste modifiers (e.g., tastants, masking agents and the like), flavor enhancers, buffering agents (e.g., the sodium and potassium salts of citric, tartaric, lactic acids and the like), preservatives (e.g., benzoates, sorbates and the like), salts, thickeners, and anti-foaming agents, any of which typically can be added alone or in combination to various beverage products or formulations to vary the taste, mouthfeel, nutritional characteristics, etc. Carbonation in the form of carbon dioxide may be added for effervescence. Optionally, caffeine can be added. Additional and alternative suitable ingredients will be recognized by those skilled in the art given the benefit of this disclosure.

In certain exemplary and non-limiting embodiments, the beverage products and formulations disclosed here comprise an acidulant as an additional beverage ingredient. Suitable acidulants include, but are not limited to, organic acids, sodium benzoate, metal bisulfates, and the like or combinations thereof. Organic acids used in certain exemplary and non-limiting embodiments of the beverage products and formulations disclosed here can serve one or more additional functions, including, for example, lending tartness to the taste of the beverage product or formulation, enhancing palatability, increasing thirst quenching effect, acting as a mild preservative, etc. Exemplary organic acids include, but are not limited to, citric acid, malic acid, ascorbic acid, tartaric acid, lactic acid, adipic acid, fumaric acid, gluconic acid, succinic acid, maleic acid, and the like or combinations thereof. Other suitable acids are known and will be apparent to those skilled in the art given the benefit of this disclosure. The particular acid or acids chosen and the amount used will depend, in part, on the other ingredients, the desired shelf life of the beverage product or formulation, as well as effects on the beverage product or formulation pH level, titratable acidity, taste, and the like. It will be within the ability of those skilled in the art, given the benefit of this disclosure, to select a suitable acid or combination of acids and the amount of acids necessary for the acidulant component of any particular embodiment of the beverage products or formulations disclosed here. For example, certain embodiments of the beverage product or formulation may include one or more organic acids in an amount from about 0.1% to about 1.0% by weight of the beverage product, e.g., about 0.2% to about 0.7% by weight, or about 0.3% to about 0.6%, or about 0.7% to about 0.8% by weight.

In certain exemplary and non-limiting embodiments, the beverage products and formulations disclosed here comprise a colorant as an additional beverage ingredient. As used here, the “colorant” is intended to mean any compound that imparts color, and includes, but is not limited to, a natural pigment, a synthetic pigment, a color additive, and the like or mixtures of any of them. Both natural and artificial colors may be used. One or more FD&C dyes (e.g., yellow #5, blue #2, red #40, etc.) and/or FD&C lakes can be used for coloring solutions, food or beverage products, or compositions disclosed here. Exemplary lake dyes include, but are not limited to, FDA-approved Lake (e.g., Lake red #40, yellow #6, blue #1, and the like or mixtures of any of them). Additionally, a mixture of FD&C dyes or a FD&C lake dye in combination with other conventional food and food colorants may be used. Examples of other suitable coloring agents, include, but are not limited to, natural agents, fruit and vegetable juices and/or powders, caramel color, riboflavin, carotenoids (for example, beta-carotene), tumeric, lycopenes, and the like or combinations thereof. The exact amount of coloring agent used will vary, depending on the agents used and the intensity desired in the finished product. Generally, if included, the coloring agent should be present at a level of from about 0.0001% to about 0.5%, from about 0.001% to about 0.1%, or from about 0.004% to about 0.1%, by weight or volume of the beverage product or formulation. Additional and alternative colorants and their respective required amounts will be recognized by those skilled in the art given the benefit of this disclosure.

In certain exemplary and non-limiting embodiments, the beverage products and formulations disclosed here comprise a flavorant as an additional beverage ingredient. Flavorants include, e.g., fruit flavors, botanical flavors, spice flavors, taste modifiers, and the like. Flavorants can be in the form of an extract, essential oil, oleoresin, juice concentrate, bottler's base, or other forms known in the art. In certain exemplary embodiments, spice or other flavors compliment that of a juice or juice combination. Exemplary flavorants suitable for use include cola flavor, tea flavor, citrus flavor, berry flavor, spice flavor, and the like or combinations thereof. In certain exemplary embodiments disclosed here, the flavorant can be present at a concentration of from about 0% to about 0.400% by weight of the final food or beverage product (e.g., from about 0.050% to about 0.200%, from about 0.080% to about 0.150%, from about 0.090% to about 0.120% by weight). Additional and alternative suitable flavorants and their respective required amounts will be recognized by those skilled in the art given the benefit of this disclosure.

In certain exemplary and non-limiting embodiments, the beverage products and formulations disclosed here comprise a desired amount of one or more fruit flavors as an additional beverage ingredient. As used here and in the appended claims, the term “fruit flavor” refers to any fruit fraction, fruit component (e.g., rind, zest, pith, pericarp, pulp, flower (e.g., petals), leaf, stem, seed, and the like), from the named fruit (FTNF) flavor (e.g., a combination of fruit essence, fruit oil and/or fruit flavor (e.g., an orange from the named fruit flavor, etc.), fruit extract (e.g., expressed, absorbed, macerated, distilled and the like), fruit oil (e.g., essential oil, folded essential oil, etc.), fruit essence, fruit puree, fruit aroma, and the like or combinations thereof that can be added to a food or beverage product to enhance flavor (e.g., to provide and/or enhance one or more high note flavors). Fruit flavors include, but are not limited to, flavors derived from orange, (e.g., mandarin, blood, navel, Valencia, etc.), tangerine, tangelo, minncola, kumquat, clementine, grapefruit, lemon, rough lemon, lime, leech lime, pummelo, pomelo, apple, grape, pear, peach, nectarine, apricot, plum, prune, pomegranate, blackberry, blueberry, raspberry, strawberry, cherry, cranberry, currant, gooseberry, boysenberry, huckleberry, mulberry, date, pineapple, banana, papaya, mango, lychee, passionfruit, coconut, guava, kiwi, watermelon, cantaloupe, honeydew melon, and the like or combinations of any of them (e.g., fruit punch). In certain exemplary embodiments, one or more citrus fruit flavors are used. The citrus flavor may include one or more of an orange fraction, an orange component, an orange extract, an orange essential oil, an orange folded essential oil, an orange aroma, an orange essence, and the like or combinations thereof. The citrus flavor may also include one or more of a fraction, component, extract, essential oil, folded essential oil, aroma, or essence of grapefruit, lemon, lime, or tangerine, among others. The citrus flavor may also include chemical compounds extracted from natural sources or synthetically produced (e.g., limonene, octanol and its derivatives, acetaldehyde, α-pinene, β-pinene, sabinene, myrcene, octanal, linalool, carene, decanal, citral, sinensal, and the like). In certain exemplary embodiments, the fruit flavor is present in an amount from about 0.001% to about 0.005% by weight of the beverage product or formulation, from about 0.01% to about 0.05% by weight, or in an amount of approximately about 0.01% to about 0.5% by weight. Additional and alternative suitable fruit flavors and their respective required amounts will be recognized by those skilled in the art given the benefit of this disclosure.

In certain exemplary and non-limiting embodiments, the beverage products and formulations disclosed here comprise a botanical flavor as an additional beverage ingredient. As used here and in the appended claims, the term “botanical flavor” refers to flavors derived from parts of a plant other than the fruit. As such, botanical flavors can include those flavors derived from essential oils and extracts of nuts, bark, roots and leaves. Examples of such flavors include, but are not limited to, cola flavors, tea flavors, spice flavors, and the like or mixtures of any of them. Additional and alternative suitable botanical flavors will be recognized by those skilled in the art given the benefit of this disclosure.

In certain exemplary and non-limiting embodiments, the beverage products and formulations disclosed here comprise a spice flavor as an additional beverage ingredient. Non-limiting examples of spice flavors include cassia, clove, cinnamon, pepper, ginger, vanilla, cardamom, coriander, root beer, sassafras, ginseng, and others. In certain exemplary embodiments disclosed here, such spice or other flavors compliment that of a fruit flavor. Additional and alternative suitable spice flavors will be recognized by those skilled in the art given the benefit of this disclosure.

In certain exemplary and non-limiting embodiments, the beverage products and formulations disclosed here comprise a taste modifier as an additional beverage ingredient. Taste modifiers may provide their own characteristic flavor, or may have little or no flavor impact by themselves. Taste modifiers have any one or more of the properties of reducing, masking, or eliminating undesirable taste characteristics, or enhancing desirable taste characteristics, for example, by controlling one or more of sweetness, sourness, bitterness, saltiness, mouthfeel, or taste temporal effects. Non-limiting examples of undesirable taste characteristics reduced by taste modifiers include one or more of bitter aftertaste, metallic aftertaste, astringency, thin mouthfeel, harshness, delayed sweetness onset, lingering sweetness, excess sourness, and other off-notes. Non-limiting examples of desirable taste characteristics enhanced by taste modifiers include one or more of sweetness intensity or impact, fullness or body, and smoothness, among others. Non-limiting examples of taste modifiers include, but are not limited to, organic acids (e.g., citric acid, malic acid, ascorbic acid, tartaric acid, lactic acid, adipic acid, fumaric acid, gluconic acid, succinic acid, maleic acid, among others), propylene glycol, glycerol, ethanol, commercially available products (e.g., Symrise™ Natural Flavor, Sweetness Enhancer Type SWL 196650, Firmenich Natural Flavor (Modulasense™ Type) 560249 T, and Firmenich™ Natural Flavor (Modularome™ Type) 539612 T, etc.), and the like or combinations thereof. It will be within the ability of those skilled in the art, given the benefit of this disclosure, to select suitable additional or alternative taste modifiers for use in various embodiments of the beverage products and formulations disclosed here.

In certain exemplary and non-limiting embodiments of the beverage products and formulations disclosed here, the one or more flavorants can be used in the form of an emulsion. A flavoring emulsion can be prepared by mixing some or all of the flavorings together, optionally together with other ingredients of the beverage product, and an emulsifying agent. The emulsifying agent may be added with or after the flavoring agents are mixed together. In certain exemplary embodiments the emulsifying agent is water-soluble. Exemplary and non-limiting examples of suitable emulsifying agents include gum acacia, modified starch, carboxymethylcellulose, gum tragacanth, gum ghatti, other suitable gums, etc. Additional suitable emulsifying agents will be apparent to those skilled in the art of beverage formulations, given the benefit of this disclosure. The emulsifier in exemplary embodiments comprises greater than about 3% by weight of the mixture of flavoring agent and emulsifier. In certain exemplary embodiments the emulsifier is from about 5% to about 30% of the mixture. It will be within the ability of those skilled in the art, given the benefit of this disclosure, to select suitable amounts of emulsifier for use in various embodiments of the beverage products and formulations disclosed here.

Weighting agents, which can also act as clouding agents, are typically used to keep the emulsion droplets dispersed in the beverage. Examples of such weighting agents include, but are not limited to, brominated vegetable oils, rosin esters, ester gums, and the like or combinations thereof. Common commercially available weighting agents are suitable for use in the beverage products and formulations disclosed here. Besides weighting agents, emulsifiers and emulsion stabilizers can be used to stabilize the flavor emulsion droplets. Examples of such emulsifiers and emulsion stabilizers include, but are not limited to, gums, pectins, cellulose, polysorbates, sorbitan esters, propylene glycol alginates, and the like or combinations thereof.

In certain exemplary and non-limiting embodiments, the beverage product or formulation disclosed here comprises carbon dioxide as an additional ingredient. Carbon dioxide is used to provide effervescence to certain exemplary embodiments of the beverage products and formulations disclosed here. Any of the techniques and carbonating equipment known in the art for carbonating beverages can be employed. Carbon dioxide can enhance the beverage taste and appearance and can aid in safeguarding the beverage purity by inhibiting and destroying objectionable bacteria. In certain embodiments, for example, the beverage product or formulation has a CO₂ level up to about 7.0 volumes carbon dioxide. Typical embodiments may have, for example, from about 0.5 to 5.0 volumes of carbon dioxide. As used here and independent claims, one volume of carbon dioxide is defined as the amount of carbon dioxide absorbed by any given quantity of water at 60° F. (16° C.) temperature and atmospheric pressure. A volume of gas occupies the same space as does the water by which it is absorbed. The carbon dioxide content can be selected by those skilled in the art based on the desired level of effervescence and the impact of the carbon dioxide on the taste or mouthfeel of the beverage product or formulation.

In certain exemplary and non-limiting embodiments, the beverage product or formulation comprises caffeine as an additional beverage ingredient. The amount of caffeine added is determined by the desired beverage product or formulation properties, any applicable regulatory provisions of the country where the beverage product or formulation is to be marketed, etc. The caffeine must be of purity acceptable for use in foods and beverages. The caffeine can be natural (e.g., from kola, cocoa nuts, coffee and/or tea) or synthetic in origin. In certain embodiments, the amount of caffeine can be from about 0.002% to about 0.05% by weight of the beverage product or formulation. In certain embodiments, the amount of caffeine is from about 0.005% to about 0.02% by weight of the beverage product. In certain embodiments caffeine is included at a level of 0.02% or less by weight of the beverage product. For concentrates or syrups, the caffeine level can be from about 0.006% to about 0.15%. Caffeine levels can be higher, for example, if flavored coffees which have not been decaffeinated are used since these materials contain caffeine naturally. It will be within the ability of those skilled in the art, given the benefit of this disclosure, to select suitable amounts of caffeine for use in various embodiments of the beverage products and formulations disclosed here.

In certain exemplary embodiments, the beverage products and formulations disclosed here are natural in that they do not contain anything artificial or synthetic that would not normally be expected to be in food. In certain exemplary embodiments, the beverage products and formulations disclosed here do not contain any artificial sweeteners. In certain exemplary embodiments, the beverage products and formulations disclosed here are naturally sweetened with a natural non-nutritive sweetener. As used here, a “natural” beverage ingredient is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients. Ingredients may be processed or purified through certain specified techniques, e.g., physical processes, fermentation, enzymolysis etc. Appropriate processes and purification techniques include, but are not limited to, absorption, adsorption, agglomeration, centrifugation, chopping, cooking (e.g., baking, frying, boiling, roasting, etc.), cooling, cutting, chromatography, coating, crystallization, digestion, drying (e.g., spray, freeze drying, vacuum, etc.), evaporation, distillation, electrophoresis, emulsification, encapsulation, extraction, extrusion, filtration, fermentation, grinding, infusion, maceration, microbiological (e.g., rennet, enzymes), mixing, peeling, percolation, refrigeration/freezing, squeezing, steeping, washing, heating, mixing, ion exchange, lyophilization, osmosis, precipitation, salting out, sublimation, ultrasonic treatment, concentration, flocculation, homogenization, reconstitution, enzymolysis (e.g., using enzymes found in nature), and the like or combinations thereof. Processing aids (currently defined as substances used as manufacturing aids to enhance the appeal or utility of a food component, including clarifying agents, catalysts, flocculants, filter aids, and crystallization inhibitors, etc. See 21 CFR §170.3(o)(24)) are considered incidental additives and may be used if removed appropriately.

In certain exemplary and non-limiting embodiments, the beverage products and formulations disclosed here comprise a mineral as an additional beverage ingredient. Suitable minerals include, but are not limited to, added calcium, chloride, chromium, potassium, magnesium, phosphorous, sodium, sulfur, cobalt, copper, fluorine, iodine, manganese, molybdenum, nickel, selenium, vanadium, zinc, iron, and the like or combinations thereof. The minerals may be added in any form compatible with human nutritional requirements and may be added to any desired level. The amounts in the beverage product or formulation may be at any suitable percentage of the Reference Daily Intake (RDI). For example, the mineral may be present at an upper limit of about: 2%, 5%, 10%, 20%, 25%, 30%, 40%, 50%, 60%, 75%, 100%, 150%, 200%, 300%, 400%, or about 500% of the RDI. The mineral may be present at a lower limit of about: 1%, 2%, 5%, 10%, 20%, 25%, 30%, 40%, 50%, 60%, 75%, 100%, 150%, 200%, or about 300% of the RDI. Alternatively, the amount of added mineral may be measured in international units (IU) or weight/weight (w/w). It should be understood that the term “added” (e.g., “added calcium”) as used here and in the appended claims refers to an added component obtained from external sources and does not include a component that is inherently present in the beverage product or formulation. For example, “added calcium” as used here and in the appended claims means that the calcium is obtained from external sources and does not include calcium that is inherent in the beverage product or formulation. Suitable added minerals for the beverage products and formulations disclosed here can be derived from any known or otherwise effective nutrient source that provides the targeted mineral separately. For example added calcium sources include, but are not limited to, e.g., calcium citrate, calcium phosphate, or any other calcium source suitable for use in a beverage product or formulation.

In certain exemplary and non-limiting embodiments, the beverage products and formulations disclosed here comprise a vitamin as an additional beverage ingredient. Suitable vitamins include, but are not limited to, added Vitamin A (including Vitamin A precursors, e.g., beta carotene), Vitamin B₁ (i.e., thiamine), Vitamin B₂ (i.e., riboflavin), Vitamin B₃ (i.e., niacin), Vitamin B₆, Vitamin B₇ (i.e., biotin), Vitamin B₉ (i.e., folic acid), Vitamin B₁₂ (i.e., cobalamin), Vitamin C (i.e., ascorbic acid), Vitamin D, and Vitamin E (i.e., tocopherols and tocotrienols), and Vitamin K, and the like or combinations thereof. The vitamins may be added in any form compatible with human nutritional requirements and may be added to any desired level. The amounts in the beverage product or formulation may be at any suitable percentage of the Reference Daily Intake (RDI). For example, the vitamin may be present at an upper limit of about: 2%, 5%, 10%, 20%, 25%, 30%, 40%, 50%, 60%, 75%, 100%, 150%, 200%, 300%, 400%, or about 500% of the RDI. The vitamin may be present at a lower limit of about: 1%, 2%, 5%, 10%, 20%, 25%, 30%, 40%, 50%, 60%, 75%, 100%, 150%, 200%, or about 300% of the RDI. Alternatively, the amount of added vitamin may be measured in international units (IU) or weight/weight (w/w). For example, a beverage product serving may contain 100% of the RDI of each of Vitamin E, Vitamin B3 (niacin), Vitamin B5 (pantothenic acid), Vitamin B6, and Vitamin B12. Suitable added vitamins for the beverage products and formulations disclosed here can be derived from any known or otherwise effective nutrient source that provides the targeted vitamin separately.

In certain exemplary and non-limiting embodiments the beverage products and formulations disclosed here include homogenized pulp. Homogenized pulp enhances the mouthfeel of the beverage product or formulation by providing increased viscosity. In addition, homogenized pulp provides added fruit flavor (e.g., orange flavor from orange pulp), and added sweetness to the beverage product or formulation. In certain exemplary embodiments, homogenized pulp comprises citrus pulp, e.g., orange pulp, grapefruit pulp, lemon pulp, lime pulp, among others, and mixtures of any of them. As used here, citrus pulp is defined as the ruptured juice sacs and segment walls recovered after the citrus juice extraction process. As used here, “homogenized pulp” is defined as pulp particles suspended in aqueous solution that do not separate out of suspension. Homogenized pulp may be produced by various homogenization techniques, using equipment e.g., a blender or a colloid mill. In certain exemplary embodiments, the homogenized pulp has an average particle size of about 60 to about 200 microns, about 70 to about 100 microns, or about 150 to about 250 microns; where at least 80% of the homogenized pulp particles are between 50 and 540 microns. In certain exemplary embodiments, the beverage product or formulation includes homogenized pulp in an amount from about 5% to about 20% by weight of the beverage product or formulation, e.g., about 10% to about 15% by weight.

Certain exemplary embodiments of the beverage products and formulations disclosed here include beta-glucan. Beta-glucans are polysaccharides containing glucose monomer units which are bonded by β-linkages. D-glucose is the naturally occurring isomer of glucose. The glucose monomers can be linked by 1→3, 1→4, and/or 1→6 bonds to produce, e.g., (1,3/1,4)-β-D-glucan. Beta-glucan can be derived from cereal grains, e.g., oats, barley, rye, wheat, etc. Specifically, beta-glucan can be derived from oat bran, rolled oats, whole oat flour, oatrim, whole grain barley, and dry milled barley. It has been shown that consumption of beta-glucan derived from e.g., barley fiber and/or oat fiber, reduces the risk of coronary heart disease. The inclusion of beta-glucan to a beverage product or formulation increases the viscosity to yield a fuller, more natural mouthfeel more closely resembling that of a 100% juice beverage product. In certain exemplary embodiments, the beverage product or formulation includes beta-glucan in an amount between about 0.1% by weight and about 2.0% by weight, e.g., between about 0.2% by weight and about 0.8% by weight, between about 0.4% by weight and about 0.7% by weight, between about 0.2% by weight and about 2.0% by weight.

Optionally, additional ingredients known or expected to have beneficial effects may be added. For example, the beverage product or formulation may contain one or more of the following: oils (e.g., omega-3, omega-6, etc.), herbs and spices. The herbs and spice ingredients may be in extracted form. Any suitable herb and spice known in the art may be used as an ingredient. Exemplary herbs and spices that may be added include, but are not limited to, Kava Kava, St. John's Wort, Saw Palmetto, ginseng, and the like.

In certain exemplary and non-limiting embodiments disclosed here, the beverage products and formulation disclosed here comprise at least one buffering agent as an additional beverage ingredient. Buffering agents are typically used to adjust pH. Such pH adjusters include, but are not limited to, the sodium or potassium salts of citric, tartaric, malic, fumaric, cinnamic, maleic, adipic, glutaric, lactic, and succinic acid, or any combination of them. The amount of buffering agent included will depend, of course, on the type of buffering agents and on the degree to which the pH is to be adjusted. Additional and alternative buffering agents and their respective required amounts will be recognized by those skilled in the art given the benefit of this disclosure.

In certain exemplary and non-limiting embodiments, the beverage product or formulation disclosed here have a pH with a lower limit of about 3.2, about 3.6, about 3.8, or about 4.0 and an upper limit of about 3.6, about 3.8, about 4.0, about 4.2, or about 4.5. In certain exemplary embodiments, the pH range is 3.4-4.0. In certain exemplary embodiments, the pH is at most 4.5.

In certain exemplary and non-limiting embodiments, the beverage product or formulation disclosed here comprises salt as an additional ingredient. Salts can act as a flavor potentiator and the amount used will vary, depending on the salt used and the intensity desired in the finished product. Suitable examples include, but are not limited to, alkali or alkaline earth metal chlorides (e.g., potassium chloride, sodium chloride, calcium chloride, magnesium chloride etc.), glutamates, (e.g., monosodium glutamate) and the like or combinations thereof.

In certain exemplary and non-limiting embodiments, the beverage product or formulation disclosed here comprises a thickener as an additional ingredient. As referred to here, “thickener” may include any material which increases the viscosity or increases the cream-like mouthfeel of the beverage product or formulation. The amount used will vary, depending on the salt used and the intensity desired in the finished product Examples of suitable thickeners for use in the beverage products and formulations disclosed here include, but are not limited to, carbohydrates, proteins, fats, lipids, hydrocolloids, gums, and the like or combinations thereof. In certain embodiments, the thickener may comprise gum arabic, gum karaya, gum tragacanth, gum ghatti, agar-agar, guar gum, locust bean gum, konjac, alginates, carrageenans, pectin, tara gum, xanthan gum, gellan gum, pullulan, curdlan, cellulose, microcrystalline cellulose, carboxymethylcellulose gum, gelatin, chitosan, maltodextrin, or combinations thereof.

In certain exemplary and non-limiting embodiments, the beverage product or formulation disclosed here comprises an anti-foaming agent as an additional ingredient. Examples of suitable anti-foam agents for use in the beverage products and formulations disclosed here include, but are not limited to, Silicone AF-100 FG (Thompson-Hayward Chemical Co.), Trans' Silicone Antifoam Emulsion (Trans-Chemco, Inc.), and 1920 Powdered Antifoam (Dow Corning Chemical). The amount of the anti-foam agent used is determined by the minimum amount required to prevent excessive foaming during processing of the beverage product or formulation and, if desired by the consumer of the beverage product or formulation, to prevent excessive foaming during processing of the food or beverage product into which the product is being incorporated. Additional suitable anti-foaming agents will be apparent to those skilled in the art of beverage formulations, given the benefit of this disclosure.

In certain exemplary and non-limiting embodiments, the beverage product or formulation disclosed here comprises an aroma chemical as an additional ingredient. In certain exemplary embodiments, the aroma chemical may include any chemical designated by the Flavor and Extract Manufacturers' Association (FEMA) to be Generally Recognized As Safe (GRAS). A chemical designated as GRAS by FEMA has been tested using certain standards and deemed safe for use by humans. Exemplary GRAS aroma chemicals include, but are not limited to acetic aldehyde, acetic acid, Isoamyl acetate, 3-methylbutanol, isoamyl butyrate, isoamyl hexanoate, isoamyl isovalerate, benzaldehyde, benzoic acid, benzyl acetate, benzyl alcohol, benzyl cinnamate, butyl acetate, isobutyl acetate, butanol, isobutanol, butyl butyrate, isobutyl butyrate, butyl isobutyrate, butyl hexanoate, isobutyl propionate, butyraldehyde, isobutyraldehyde, butyric acid, isobutyric acid, cinnamaldehyde, cinnamic acid, 2,3-butanedione, ethyl acetate, ethyl acetoacetate, ethyl benzoylacetate, ethyl butyrate, ethyl isobutyrate, ethyl cinnamate, ethyl heptanoate, ethyl hexanoate, ethyl lactate, ethyl 2-methylbutyrate, ethyl propionate, ethyl pyruvate, ethyl valerate, ethyl isovalerate, 2-heptanone, hexanal, hexanoic acid, hexanol, raspberry ketone, α-ionone, β-ionone, lactic acid, 2-methylbutyraldehyde, isovaleraldehyde, 2-methylbutyric acid, methyl cinnamate, methyl 2-methylbutyrate, methyl propionate, propionaldehyde, propanoic acid, propanol, pyruvic acid, valeric acid, isovaleric acid, vanillin, 4-methyl-5-hydroxyethyl thiazole, acetone, heptanoic acid, 2-methylbutyl 2-methylbutyrate, 2-isopropyl-5-methyl-2-hexenal, ethyl 3-hydroxybutyrate, 2-methylbutyl isovalerate, isoamyl isobutyrate, tiglic acid, D-2-methylbutyl acetate, L-2-methylbutanol, methanol, cyclopentadecanone, acetic anhydride, and other compounds. GRAS aroma chemicals may be extracted from natural sources or produced synthetically. It will be within the ability of those skilled in the art, given the benefit of this disclosure, to select a suitable aroma chemical or combination of aroma chemicals suitable for use in the beverage products and formulations according to this disclosure.

In certain exemplary and non-limiting embodiments, the beverage product or formulation disclosed here comprises a preservative as an additional ingredient. That is, at least certain exemplary embodiments contain an optional dissolved preservative system. Solutions with a pH below 4 and especially those below 3 typically are “microstable,” i.e., they resist growth of microorganisms, and so are suitable for longer term storage prior to consumption without the need for further preservatives. However, an additional preservative system can be used if desired. If a preservative system is used, it can be added to the beverage product at any suitable time during production, e.g., in some cases prior to the addition of the sweetener. As used here, the terms “preservation system” or “preservatives” include all suitable preservatives approved for use in food and beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants e.g., ascorbic acid, EDTA, BHA, BHT, TBHQ, dehydroacetic acid, dimethyldicarbonate, ethoxyquin, heptylparaben, etc. Other suitable preservatives for use in the beverage products and formulations disclosed here include natural preservatives, e.g., nisin, cinnamic acid, grape pomace extract, salt, vinegar, and the like. It will be within the ability of those skilled in the art, given the benefit of this disclosure, to select a suitable aroma preservative or combination of preservatives suitable for use in the beverage products and formulations according to this disclosure.

Preservatives can be used in amounts not exceeding mandated maximum levels under applicable laws and regulations. The level of preservative used typically is adjusted according to the planned final product pH, as well as an evaluation of the microbiological spoilage potential of the particular beverage formulation. The maximum level employed typically is about 0.05% by weight of the beverage product or formulation. It will be within the ability of those skilled in the art, given the benefit of this disclosure, to select a suitable amount of preservative for beverage products and formulations according to this disclosure.

In certain exemplary and non-limiting embodiments of the beverage products and formulations disclosed here, PET (polyethylene terephthalate) bottles capable of containing 12 fl. oz. are used as containers for the beverage. Methods of beverage preservation suitable for at least certain exemplary embodiments of the beverage products disclosed here include, e.g., aseptic packaging and/or heat treatment or thermal processing steps, e.g., tunnel pasteurization, hot filling, cold filling, refrigeration, etc. Such steps can be used to reduce yeast, mold and microbial growth in the beverage products. For example, U.S. Pat. No. 4,830,862 to Braun et al. discloses the use of pasteurization in the production of fruit juice beverages as well as the use of suitable preservatives in carbonated beverages. In general, heat treatment includes hot fill methods typically using high temperatures for a short time, e.g., about 190° F. (87.8° C.) for 10 seconds, tunnel pasteurization methods typically using lower temperatures for a longer time, e.g., about 160° F. (71.1° C.) for 10-15 minutes, and retort methods typically using, e.g., about 250° F. (121° C.) for 3-5 minutes at elevated pressure, i.e., at pressure above 1 atmosphere. Many cold filled products must also be refrigerated to ensure adequate shelf life. Cold fill temperatures are those that fall below the hot fill range, with some techniques requiring temperatures just above room temperature, some at 45° F., and some at 150°-160° F. Cold filling has traditionally been used for milk and various other dairy items, sparkling waters and wines, beers, and juices. Juice makers typically combine cold filling and pasteurization combinations in combination with refrigerated distribution and storage. Cold filled juices sold in a refrigerated state are typically packaged in plastic bottles or gabletop cartons.

Certain exemplary methods, beverage products and formulations in accordance with the disclosure are described in greater detail in the examples presented below by way of illustration.

### Example 1

### Preparation of Orange Juice Beverage Product Using Probiotic Bacteria

The beverage product is prepared with orange juice and blended with sufficient additives and beta-glucan to meet target specifications for Brix and acidity to form a first mixture. A beverage product composition and its various formulas using orange juice are shown in Table 1 below.

TABLE 1

| | Formu- | Formu- | Formu- | Formu- |
|---|---|---|---|---|
| | la 1 | la 2 | la 3 | la 4 |
| | % by | % by | % by | % by |
| Ingredients | weight | weight | weight | weight |
| Orange juice | 30.000 | 30.000 | 30.000 | 30.000 |
| Filtered water | 61.432 | 58.716 | 56.000 | 52.284 |
| Homogenized pulp | 7.695 | 10.260 | 32.825 | 15.390 |
| Rebaudioside A | 0.012 | 0.016 | 0.020 | 0.024 |
| Malic acid | 0.108 | 0.144 | 0.180 | 0.216 |
| Citric acid | 0.108 | 0.144 | 0.180 | 0.216 |
| Potassium citrate | 0.126 | 0.168 | 0.210 | 0.252 |
| Citrus flavor | 0.021 | 0.028 | 0.035 | 0.042 |
| Orange oil and | 0.018 | 0.024 | 0.030 | 0.036 |
| tocopherol mixture | | | | |
| Beta carotene | 0.012 | 0.016 | 0.020 | 0.024 |
| Vitamin mixture | 0.048 | 0.064 | 0.080 | 0.096 |
| Cargill, Inc. | 0.420 | 0.420 | 0.420 | 0.420 |
| Barliv ™ | | | | |
| beta-glucan | | | | |
| | 100.000 | 100.000 | 100.000 | 100.000 |

After the formation of the first mixture, the first mixture is then pasteurized using one of several known commercial pasteurization methods (e.g., flash pasteurization) and then cold-filled into 12 fl. oz. polyethylene terephthalate (PET) bottles. Freeze-dried HOWARU® Bifidobacterium lactis HN019 probiotic bacteria from Danisco is measured, mixed and rehydrated into 0.1% peptone water to meet target specifications for initial inoculation per 12 fl. oz. bottle. Similar results are obtained by using similar probiotic bacteria, examples of which were mentioned previously. One such inoculated juice mixture and its various formulas is illustrated in Table 2. Prior to capping, inoculation of the juice with the bacteria is performed with a sterile pipette under a clean, HEPA air hood. After inoculation, the bottle is capped under the hood and stored at 35° F. in the dark or in otherwise UV shielded conditions.

TABLE 2

| | Formu- | Formu- | Formu- | Formu- |
|---|---|---|---|---|
| | la 1 | la 2 | la 3 | la 4 |
| | % by | % by | % by | % by |
| Ingredient | weight | weight | weight | weight |
| Orange juice | 42.0000 | 42.0000 | 42.0000 | 42.0000 |
| Filtered water | 57.3192 | 56.8086 | 56.2980 | 55.7874 |
| Rebaudioside A | 0.0048 | 0.0084 | 0.0120 | 0.0156 |
| Malic acid | 0.0720 | 0.1260 | 0.1800 | 0.2340 |
| Citric acid | 0.0720 | 0.1260 | 0.1800 | 0.2340 |
| Probiotic mixture | 0.1200 | 0.2100 | 0.3000 | 0.3900 |
| Cargill, Inc. | 0.2400 | 0.4200 | 0.6000 | 0.7800 |
| Barliv ™ | | | | |
| beta-glucan | | | | |
| Potassium citrate | 0.0800 | 0.1400 | 0.2000 | 0.2600 |
| Citrus flavors | 0.0400 | 0.0700 | 0.1000 | 0.1300 |
| Orange oil and | 0.0120 | 0.0210 | 0.0300 | 0.0390 |
| tocopherols | | | | |
| Beta carotene | 0.0080 | 0.0140 | 0.0200 | 0.0260 |
| Vitamin mixture | 0.0320 | 0.0560 | 0.0800 | 0.1040 |
| | 100.000 | 100.0000 | 100.0000 | 100.0000 |

To test the viability of the probiotic bacteria over time, an exemplary test procedure as outlined in Test Method 1 is followed.

### Test Method 1

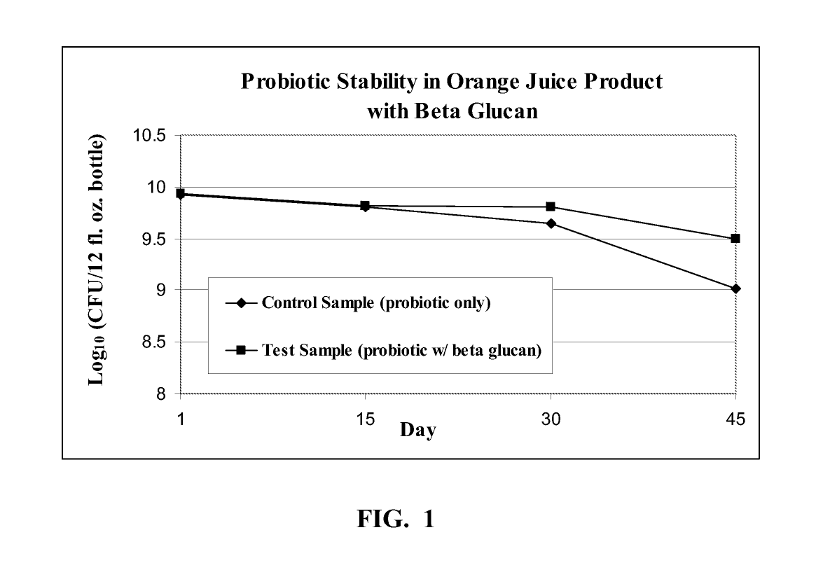

Samples from the inoculated, capped 12 fl. oz. containers as disclosed in Example 1 are selected randomly every 15 days for 45 days and tested for Bifidobacterium lactis HN019 enumeration. A standard enumeration procedure as used in the industry is followed (see Exemplary Enumeration Procedure below). Samples are plated at −4, −5, and −6 dilutions on MRS agar with Cysteine HCl, incubated, and read after 48 hours. Exemplary results from these studies are displayed in FIG. 1. Each data point reflects a composite of multiple samples (typically 2 or 3). Unless mentioned otherwise, all probiotic bacterial counts recited in this disclosure are tested according to the aforementioned enumeration testing procedure and are performed on freshly bottled or otherwise freshly packaged beverage product stored in the dark or in otherwise UV shielded conditions at 35° F.

### Exemplary Enumeration Procedure

11 mL of juice sample is diluted by aseptically pipetting into 99 mL of room temperature sterile Butterfield's Phosphate Buffer Solution (BPBS) to form a sample mixture followed by treatment in a stomacher for 60 seconds. Serial dilutions are made by aseptically pipetting 1 mL of sample mixture into 99 mL of BPBS until the desired dilution is obtained.

Sterile, molten (45° C.) Lactobacilli MRS agar is supplemented with sterile 5% Cysteine-HCl solution to obtain a final Cysteine-HCL concentration of 0.05% in MRS agar.

Sample sizes of 1 mL or 0.1 mL of the diluted juice sample mixture is added to sterile Petri dishes. Approximately 15 mL of the agar medium is poured into the Petri dishes and swirled to adequately mix the agar medium and juice sample before allowing to solidify at room temperature on a cool level surface. The plates are incubated at 37-38° C. under anaerobic conditions (H₂/CO₂) for 48-72 hours. Plates with colony counts of 25-250 are counted and multiplied by the serial dilution factor to record the viable cell count per mL of sample.

Those of ordinary skill in the art will understand that, for convenience, some ingredients are described here in certain cases by reference to the original form of the ingredient in which it is added to the beverage products, formulations and methods disclosed here. Such original form may differ from the form in which the ingredient is found in the finished beverage product or formulation. Thus, for example, sucrose and liquid sucrose would typically be substantially homogenously dissolved and dispersed in a solution. Likewise, other ingredients identified as a solid, concentrate (e.g., juice concentrate), etc. would typically be homogenously dispersed throughout the sweetener, solution or composition, rather than remaining in their original form. Thus, reference to the form of an ingredient of a beverage product or formulation should not be taken as a limitation on the form of the ingredient in the beverage product of formulation, but rather as a convenient means of describing the ingredient as an isolated component of the beverage product or formulation.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

1.-46. (canceled)

47. A beverage product comprising:
orange juice in an amount of at least 40% by weight of the beverage product,
citrus fruit flavor additive in an amount of 0.050%-0.20% by weight of the beverage product,
rebaudioside A in an amount of 0.005%-1.0% by weight of the beverage product,
at least one buffering agent,
at least one vitamin,
gum arabic,
probiotic bacteria, and
beta-glucan in an amount of 0.20%-2.0% by weight of the beverage product,
where the beverage product has a pH of at most 4.5.

48. The beverage product of claim 47, where the orange juice consists essentially of not-from-concentrate orange juice.

49. The beverage product of claim 47, where the orange juice consists essentially of from-concentrate orange juice.

50. The beverage product of claim 47, further comprising at least one additional fruit juice selected from the group consisting of pineapple juice, apple juice, mango juice, coconut juice, and a combination of any of them.

51. The beverage product of claim 47, further comprising at least two additional juices selected from the group consisting of pineapple juice, apple juice, mango juice, coconut juice, and a combination of any of them.

52. The beverage product of claim 47, where the orange juice is a combination of not-from-concentrate orange juice and from-concentrate orange juice.

53. The beverage product of claim 47, further comprising a vegetable component.

54. The beverage product of claim 47, further comprising at least one additional natural non-nutritive sweetener.

55. The beverage product of claim 54, where the natural non-nutritive sweetener is selected from the group consisting of a rebaudioside, a steviol glycoside, Stevia rebaudiana extract, Lo Han Guo, mogroside V, monatin, glycyrrhizin, thaumatin, monellin, brazzein, and mixtures of any of them.

56. The beverage product of claim 54, where the natural non-nutritive sweetener is selected from the group consisting of rebaudioside B, rebaudioside C, rebaudioside D, rebaudioside E, steviolbioside, dulcoside A, and a combination of any of them.

57. The beverage product of claim 56, where the natural non-nutritive sweetener is 0.005%-1.00% by weight of the beverage product.

58. The beverage product of claim 47, where the probiotic bacteria comprises Bifidobacterium spp., Lactobacillus spp., or mixtures of any of them.

59. The beverage product of claim 47, wherein the beverage product comprises at least 1.0×109 CFU/12 fl. oz. of probiotic bacteria when the beverage product is stored in the dark or in otherwise UV shielded conditions for 45 days at a temperature of 35° F.

60. The beverage product of claim 47, wherein the beverage product comprises at least 5.0×109 CFU/12 fl. oz. of probiotic bacteria when the beverage product is stored in the dark or in otherwise UV shielded conditions for 45 days at a temperature of 35° F.

61. The beverage product of claim 47, where the beta-glucan is derived from at least one of oat bran, rolled oats, whole oat flour, oatrim, whole grain barley, dry milled barley, or mixtures of any two or more of them.

62. The beverage product of claim 47, where the beta-glucan is 0.20%-0.80% by weight of the beverage product.

63. The beverage product of claim 47, further comprising at least one additional ingredient selected from the group consisting of taste modifiers, organic acids, flavorants, minerals, colorants, and mixtures of any of them.

64. The beverage product of claim 63, where the additional ingredient is at least one organic acid.

65. The beverage product of claim 64, where the organic acid is selected from the group consisting of citric acid, malic acid, ascorbic acid, tartaric acid, lactic acid, and mixtures of any of them.

66. The beverage product of claim 64, where the organic acid is 0.1%-1.0% by weight of the beverage product.

67. The beverage product of claim 63, where the additional ingredient is at least one mineral.

68. The beverage product of claim 67, where the mineral comprises added calcium.

69. The beverage product of claim 63, where the additional ingredient is at least one colorant.

70. The beverage product of claim 47, where the vitamin comprises added Vitamin D.

71. The beverage product of claim 47, further comprising at least one homogenized pulp.

72. The beverage product of claim 71, where the homogenized pulp comprises orange pulp.

73. The beverage product of claim 72, where the homogenized pulp is 5%-20% by weight of the beverage product.

74. The beverage product of claim 47, where the beverage product has the characteristic that if tested after 45 days of storage in hermetically sealed 12 fl. oz. PET vessels stored in the dark or in otherwise UV shielded conditions at a refrigeration temperature of 35° F. the beverage product has an increased shelf life when compared to the same beverage product without the beta-glucan.

75. The beverage product according to claim 74, where the shelf life is increased by at least 10%.

76. A beverage product formulation comprising:
orange juice in an amount of at least 40% by weight of the beverage product,
rebaudioside A in an amount of 0.005%-1.0% by weight of the beverage product,
citrus fruit flavor additive in an amount of 0.050%-0.20% citrus by weight of the beverage product,
at least one buffering agent,
at least one vitamin,
gum arabic,
probiotic bacteria, and
beta-glucan in an amount of 0.20%-2.0% by weight of the beverage product,
where the beverage product formulation has a pH of at most 4.5 and where the beverage product formulation has at least a 10% greater pro biotic concentration when tested after storing for 45 days in hermetically sealed 12 fl. oz. PET vessels in the dark or in otherwise UV shielded conditions at 35° F. than the beverage product formulation without the beta-glucan when tested after 45 days in hermetically sealed 12 fl. oz. PET vessels stored in the dark or in otherwise UV shielded conditions at 35° F.

77. A beverage product comprising:
not-from-concentrate orange juice in an amount of at least 40% by weight of the beverage product,
rebaudioside A in an amount of 0.005%-1.0% by weight of the beverage product,
citrus fruit flavor additive in an amount of 0.050%-0.20% by weight of the beverage product,
at least one vitamin,
at least one buffering agent,
gum arabic,
probiotic bacteria; and
beta-glucan in an amount of at least 0.20% by weight of the beverage product;
where the beverage product has a pH of at most 4.5 and the probiotic bacteria comprise viable bacteria at a concentration of at least 1.0×109 CFU/12 fl. oz. of the packaged beverage product when tested after storing for 45 days in hermetically sealed 12 fl. oz. PET vessels stored in the dark or in otherwise UV shielded conditions at 35° F.
